(19) United States
(12) Patent Application Publication
(10) Pub. No.: US 2013/0258067 A1
(43) Pub. Date: Oct. 3, 2013

(54) SYSTEM AND METHOD FOR TRINOCULAR DEPTH ACQUISITION WITH TRIANGULAR SENSOR

(71) Applicants: Dong-Qing Zhang, Bridgewater, NJ (US); Jiefu Zhai, Cupertino, CA (US); Zhe Wang, Plainsboro, NJ (US)

(72) Inventors: Dong-Qing Zhang, Bridgewater, NJ (US); Jiefu Zhai, Cupertino, CA (US); Zhe Wang, Plainsboro, NJ (US)

(73) Assignee: Thomson Licensing

(21) Appl. No.: 13/991,636

(22) PCT Filed: Dec. 8, 2010
(86) PCT No.: PCT/US10/03122

§ 371 Date: Jun. 5, 2013

(51) Int. Cl. H04N 13/02

(52) U.S. Cl. CPC H04N 13/025
USPC 348/48

(57) ABSTRACT

A depth acquisition system utilizes at least three sensors with at least one sensor in a non-colinear configuration to increase depth information. This configuration provides both vertical and horizontal depth information to be combined to enhance image quality, especially in three-dimensional image gathering. Vertical sensor pairs aid in determining disparities for horizontal edges and make depth estimations for horizontal edges more accurate.

### BACKGROUND

The standard method for acquiring depths uses two cameras to capture the pictures of a scene at different locations, and infers the depth map from the pixel disparities in the two pictures. The algorithm to compute the disparity or depth map using two pictures is known as stereo matching algorithm, or stereo algorithm (see, D. Scharstein and R. Szeliski. A Taxonomy and Evaluation of Dense Two-Frame Stereo Correspondence Algorithms. IJCV 47(1/2/3): 7-42, April-June 2002).

However, acquiring depth maps using two cameras is an unreliable method because part of the 3D information is lost during the imaging projection process that converts a 3D scene into a 2D image. In order to further enhance the accuracy of depth acquisition, researchers have proposed using more cameras so that additional information can be captured. For example, one enhanced solution is to use a camera array that consists of a 2D matrix of cameras (see, Bennett Wilburn, Michael Smulski, Hsiao-Heng Kelin Lee, and Mark Horowitz, “The Light Field Video Camera”, Proc. Media Processors 2002, SPIE Electronic Imaging 2002). However, camera arrays may be too costly or too clumsy for some application scenarios, for example, desktop 3D applications, 3D movie making, walking robots etc. Therefore, a simplified solution (see, R. Tanger, N. Atzpadin, M. Muller, C. Fehn, P. Kauff C. Herpel. Depth Acquisition for Post-Production Using Trinocular Camera Systems and Trifocal Constraint. In Proceedings of International Broadcast Conference, pages 329-336, Amsterdam, The Netherlands, September 2006) that only uses three cameras has been proposed, which should be more accurate than the traditional two camera systems, but significantly cheaper than the camera array solution.

The solution proposed in Tanger uses three cameras positioned on a horizontal rig. Stereo algorithm is generally realized by matching local features around pixels among the captured images and finding the best-match pixels. The disparity of a pixel, which is the inverse of its depth value, is the relative coordinate of the matched pixels in an image pair. One of the problems of stereo matching is that if the object has horizontal texture on the surface, the local features of the pixels on the horizontal texture are the same for all cameras, therefore, there could be multiple best matches, and thus the disparity value becomes undefined. Therefore, for the objects with horizontal texture or edges, stereo algorithms could become significantly inaccurate because the disparities of the horizontal edges cannot be created by the horizontal camera displacement. This problem still cannot be solved by the solution proposed in Tanger, due to the fact although three cameras are used instead of two, all camera pairs are still horizontally displaced, and the disparities of horizontal edges would not be created to result in reliable depth estimation.

### SUMMARY

By positioning one of three sensors (e.g., cameras) vertically relative to one of the other two sensors, it forms a horizontal sensor pair and a vertical sensor pair. The vertical sensor pair aids in calculating disparities for horizontal edges and makes a depth estimation for horizontal (or near-horizontal) edges more accurate. Depth acquisition systems of this type allow acquisition of depth of a scene using multiple sensors located at different locations to improve the existing depth acquisition method using trinocular camera systems. This type of trinocular depth acquisition system provides a stable, cost effective solution while enhancing image textures and other depth information.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is a depth acquisition system in accordance with an aspect of an embodiment.

FIG. 2 is an example of a depth acquisition system employed to solve pixel matching in accordance with an aspect of an embodiment.

FIG. 3 is another depth acquisition system in accordance with an aspect of an embodiment.

FIG. 4 is an example of a two sensor depth acquisition system in accordance with an aspect of an embodiment.

FIG. 5 is an example of pixel disparity in accordance with an aspect of an embodiment.

FIG. 6 is an example of a three sensor horizontal depth acquisition system in accordance with an aspect of an embodiment.

FIG. 7 is an illustration of an ill-posed stereo matching problem in accordance with an aspect of an embodiment.

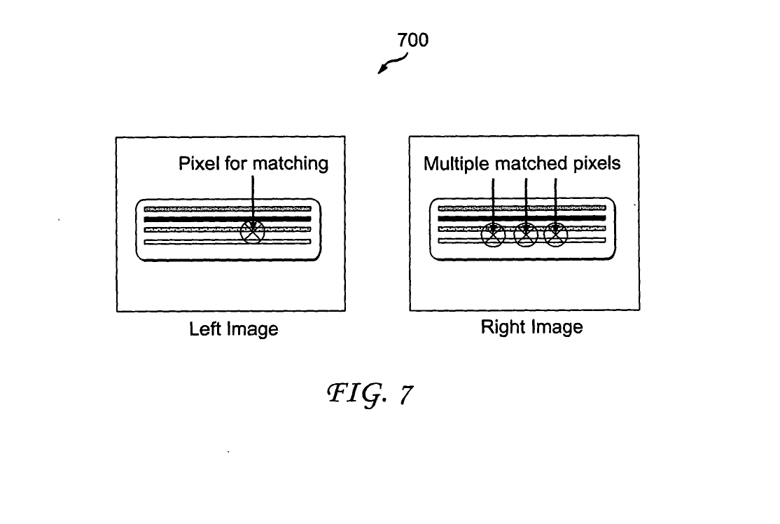

FIG. 8 is an illustration of an ill-posed problem for a horizontal depth acquisition system in accordance with an aspect of an embodiment.

FIG. 9 is examples of other instances of depth acquisition systems in accordance with an aspect of an embodiment.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting instances and embodiments of the invention are intended to encompass both structural and functional equivalents. Additionally, it is intended that such equivalents include both currently known equivalents as well as equivalents developed in the future (i.e., any elements developed that perform the same function, regardless of structure).

A trinocular depth acquisition system uses three sensors (i.e., cameras) to simultaneously take three images of the same scene at different sensor locations, and infer the depths from the three images using the parallax caused by spatial sensor displacement. Compared to depth acquisition using two sensors, trinocular depth acquisition is more accurate because additional information for inferring depth is acquired using an extra sensor. In the traditional trinocular depth acquisition system, the three sensors are positioned on a horizon and their sensor centers form a straight line. However, horizontal sensor positioning is not an optimal sensor spatial configuration due to the ill-posed nature of the depth acquisition problem (described below). Thus, by utilizing a spatial configuration with at least three sensors positioned, for example, as a triangle, results in more accurate depth acquisition.

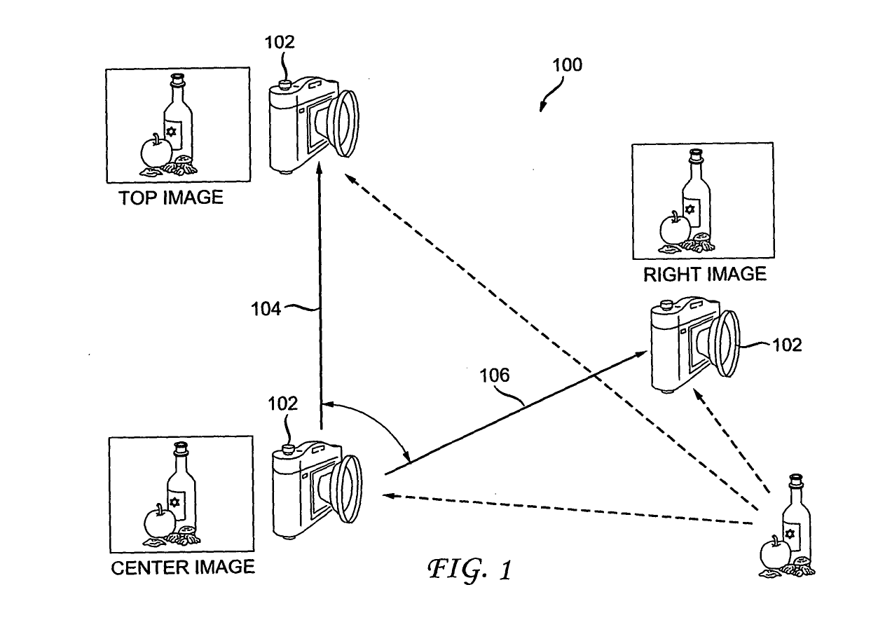

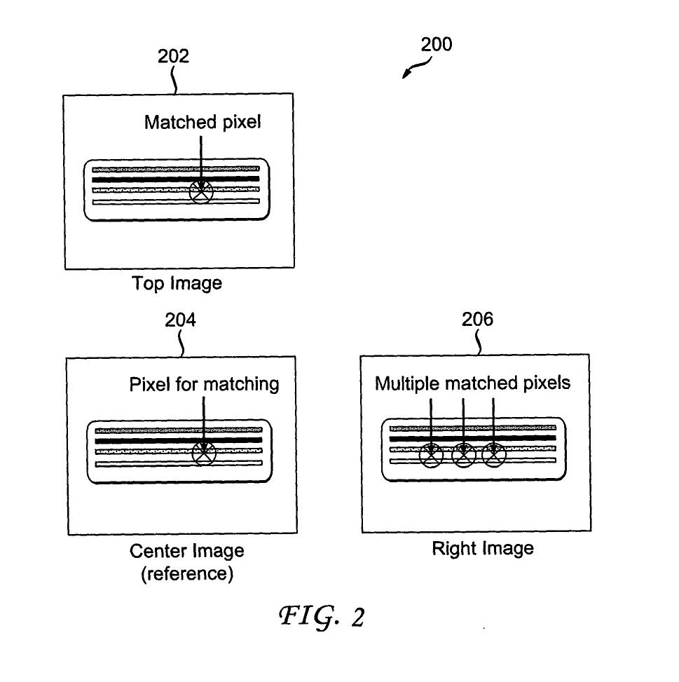

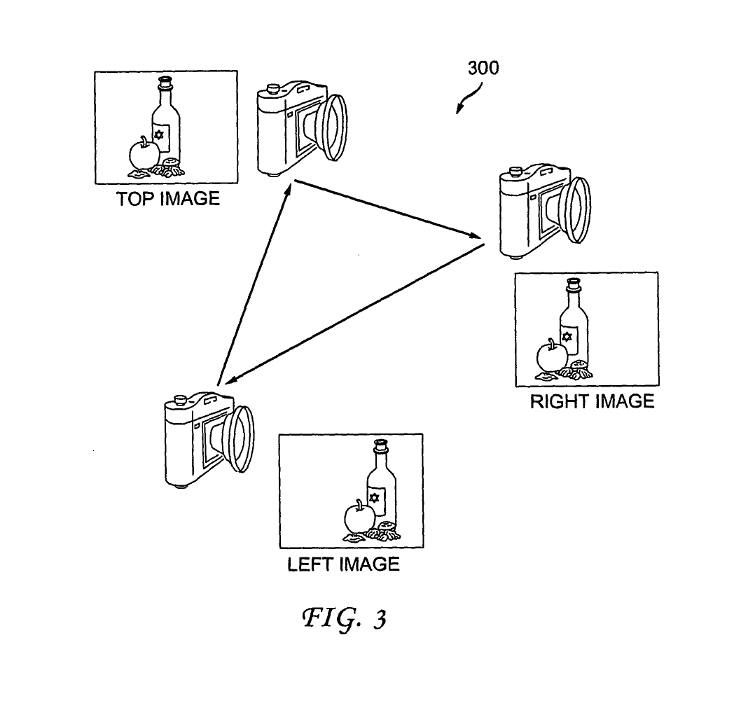

FIG. 1 illustrates an example depth acquisition system 100 that uses three sensors 102 (e.g., cameras) with a unique spatial configuration. Contrastingly different from prior systems (see, Tanger), this system 100 positions the three sensors 102 on a triangle, which creates two sensor arms 104, 106. This system 100 allows its horizontal sensor pair to better capture the disparities caused by vertical edges, and its vertical sensor pair to better capture the disparities caused by horizontal edges. For a horizontal texture example 200 (described below), the three captured images 202-206 and its corresponding search process are illustrated in FIG. 2. It can be noticed that although the horizontal disparities of the texture area are not created by the horizontal sensor pair, the disparities are created by the vertical sensor pair, therefore, the stereo matching problem becomes well-posed (discussed below) for the texture image captured by the vertical sensor pair. In a triangular sensor configuration, a horizontal sensor arm and a vertical sensor arm are not necessarily orthogonal to each other. For example, another triangular configuration 300 that can result in more stable sensor mounting is shown in FIG. 3. However, the orthogonal sensor positioning shown in FIG. 1, results in minimum redundancy between the two sensor pairs compared to other configurations.

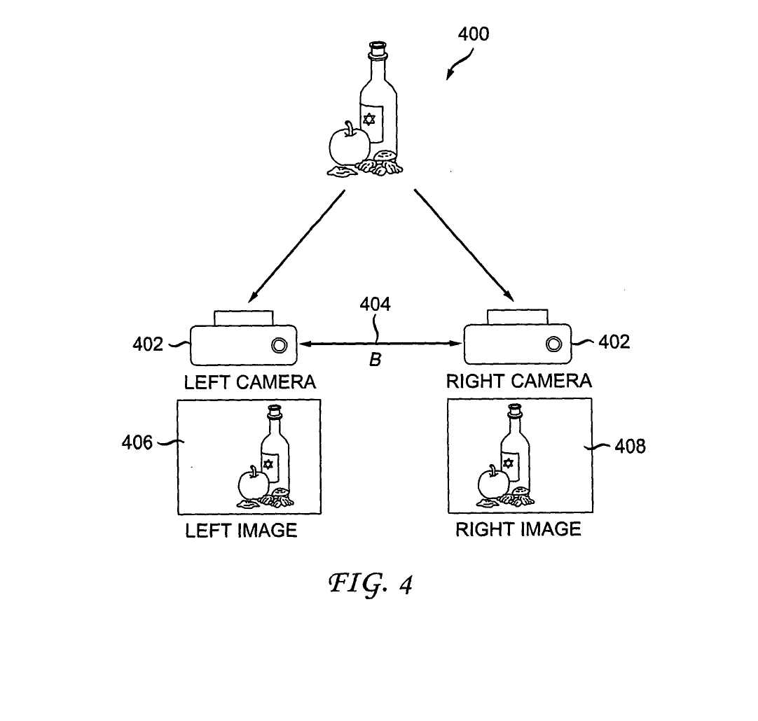

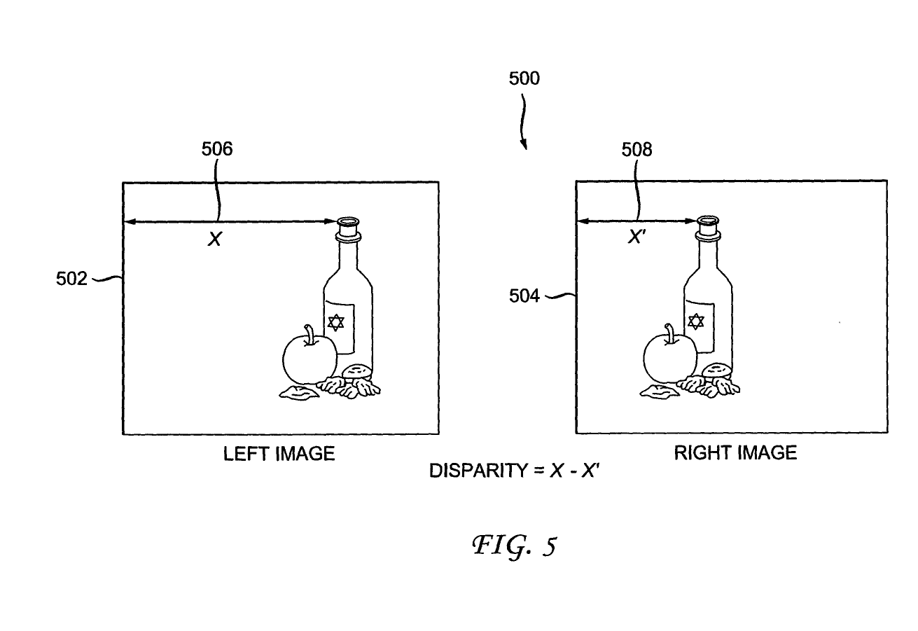

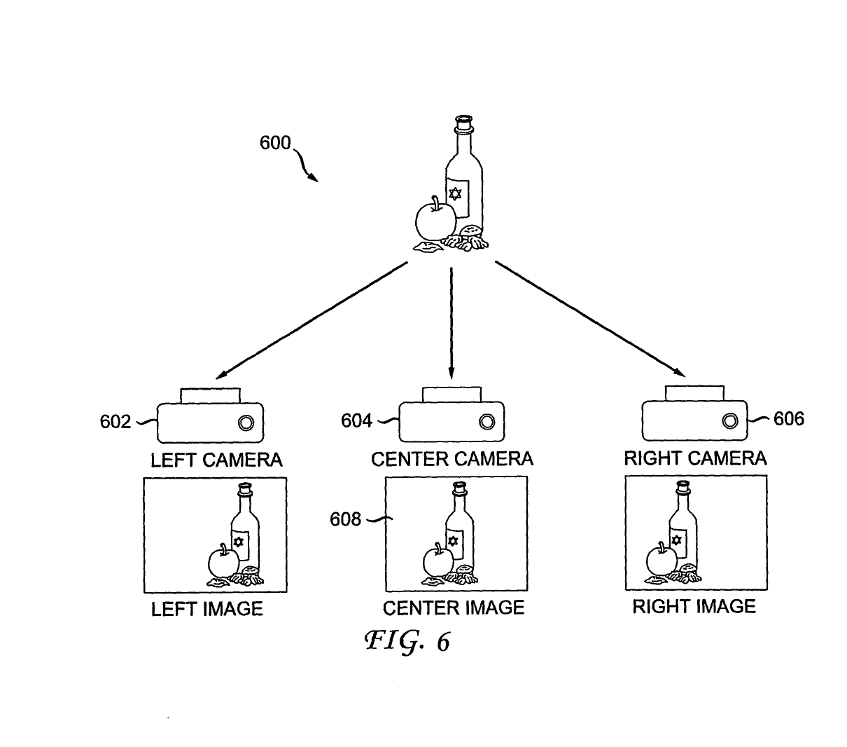

To better understand this depth acquisition method, an overview of a depth acquisition method 400 using two sensors 402 and stereo matching is illustrated in FIG. 4. In the depth acquisition system 400, the two sensors 402 are positioned horizontally with a certain distance apart 404. The distance between the two sensors 402 is called the baseline of the sensor pair, denoted as B. The baseline determines the maximum size of the disparities created by the sensor pair. A larger baseline results in a larger disparity of a pixel given the same depth value. As illustrated in FIG. 5, the disparity 500 of a pixel in a reference image (left image 502 or right image 504) is the relative coordinate of the corresponding pixels 506, 508 in the image pair 502, 504. The two sensors have to be calibrated and rectified. The calibration and rectification process is performed to make sure that the two sensors have the same parameters and their focal planes are co-planed (i.e. on the same plane). If the two sensors are calibrated and rectified, the matched pixels are co-located at a horizontal scanline, and there is a simple relationship between a disparity value D of a pixel and a depth Z of the corresponding scene point:

$$Z = \frac{Bf}{D} \qquad ( Eq . 1 )$$

Where B is the baseline, f is the focal length of the cameras, Z is the depth value of a scene point, and D is the disparity value of the pixel corresponding to the scene point. Based on the above equation (Eq. 1), it is evident that the depth value of a pixel can be calculated using the above simple relation given its disparity value. As shown in FIG. 6, for a trinocular camera system 600, the principle is the same except that three sensors 602-606 are used, which results in three sensor pairs. And an image 608 taken by a sensor 604 in the middle is commonly used as a reference image.

The disparity values of pixels can be obtained by stereo matching algorithms. For a given pixel in a reference image (without loss of generality, assuming to be the left image), the stereo matching algorithm estimates the disparity by searching the corresponding pixel along the scanline in the right image by calculating the difference of the local features between a given pixel and potential matched pixels. The pixel in a right image that has a minimum local feature difference is chosen as the correspondent pixel, and the relative coordinate between the matched pixel in the right image and the input pixel in the left image is the disparity (see, FIG. 5). The local feature is a vector that represents the local appearance around the given pixel. In many existing systems, the local feature is just the image patch around the given pixel. Therefore, the stereo matching algorithm relies on a local feature difference to infer disparity values.

If there is no local feature difference created by a sensor pair, which is usually the case for flat regions without texture, then the disparity value is undefined because there can be multiple best-match pixels in the right image corresponding to the given pixel in the left image. This is called an ill-posed problem, since multiple solutions exist given an input. The ill-posed problem of stereo matching is generally solved by imposing additional constraints, such as spatial smoothness constraints, so that the ill-posed problem becomes well-posed. The constraints can be considered as prior knowledge about the resulting depth map, for instance, the depth map has to be piecewise smooth. However, imposing spatial smoothness or other constraints does not ensure the correctness of the disparity, because the prior knowledge, for instance the smoothness to a certain extent, might not be always true for the local area of every pixel.

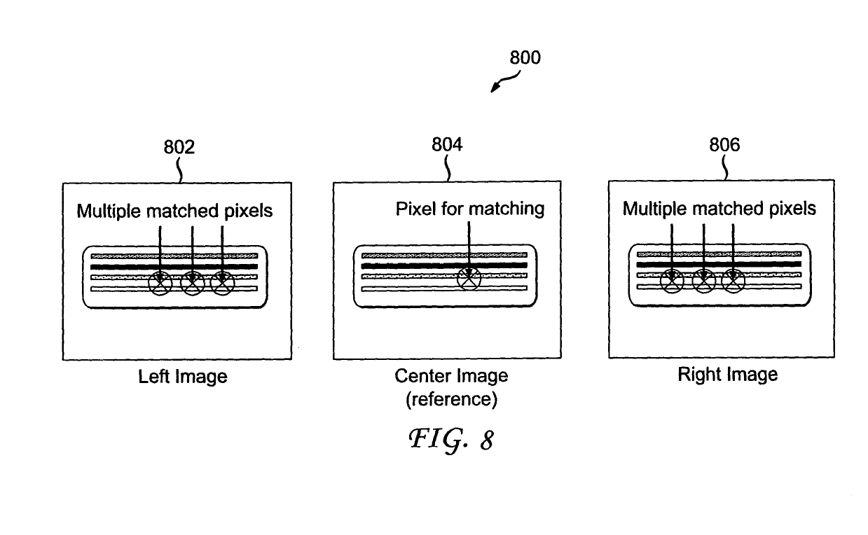

For a sensor pair on a horizontal plane, even if there is texture on the object surface, usually the disparities still cannot be accurately obtained. This is illustrated in FIG. 6, where an object in a scene only has horizontal texture. It can be observed that because the texture is horizontal, the horizontal displacement of sensors does not create visible horizontal disparities for the pixels inside the texture area. Therefore, as shown in the example 800 in FIG. 8, when the stereo matching algorithm searches the corresponding pixels along the horizontal scanline in the right image 806 for a given pixel in the left image 802, there can be multiple best-match pixels in the right image 806 because the local features of those pixels are all the same. Furthermore, this problem cannot be solved by using three sensors positioned on a horizontal plane. As illustrated in the example 800 in FIG. 8, it can be seen that for both sensor pairs, there are multiple best matches, and, therefore, the disparity becomes unreliable if one of the best matches is arbitrarily chosen as the corresponding pixel.

Mathematically, a stereo matching algorithm can be formulated as a cost function minimization problem. For a given pixel P (x, y) in a left image, where x,y is the coordinate of the pixel, the stereo match algorithm searches the pixels P (x−d, y) (where d is the disparity) in a right image and computes the feature distance D (Fₗ(x, y), Fᵣ(x−d, y), where Fₗ(x, y) is the local feature at the pixel location (x,y) in the left image and Fᵣ(x, y) is the local feature at the pixel location (x,y) in the right image. The estimated disparity d for the pixel located at (x,y) is therefore the disparity value which minimizes the feature distance:

d (x, y)=argmin_{d}[D(Fₗ(x, y), Fᵣ(x−d, y))] (Eq. 2)

The disparity search range is from 0 to a predefined maximum disparity value dₘₐₓ, namely 0≦d≦dₘₐₓ. For the horizontal texture example described above, for a given pixel P (x, y) in the texture area in the left image, the features Fᵣ(x−d, y) can be all the same for every d value, therefore the distance function is a constant with respect to d. And the estimated disparity d is unreliable.

In sharp contrast, if a non-planar three-sensor system is applied, where the sensor pairs are perpendicular to each other in position (see, FIG. 1), there are two feature distance functions, the horizontal distance function D (Fₗ(x, y), Fᵣ(x−d, y), and the vertical distance function D (Fₗ(x, y), Fₜ(x, y−d), where Fₜ(x, y) is the local feature at the pixel location (x,y) in the top image. To simplify the example, the baseline B has been assumed to be identical for the two sensor pairs. However, this is not required. Therefore, for the same depth value, the disparity d is the same for both sensor pairs. If the baselines are not the same, the disparity dₕ of the horizontal sensor pair can be transformed to the disparity dᵥ of the vertical camera pair by a simple rule:

$${d}_{v} = {d}_{h} \frac{{B}_{v}}{{B}_{h}} ,$$

where Bᵥ and Bₕ are the baselines for the vertical and horizontal sensor pairs. Given the two sensor pairs, these two distance functions can be combined by different rules, such as addition, weighted addition, multiplication etc. For example, if simple addition is used for the combination, the disparity estimation equation becomes:

d(x,y)=argmin_{d}[D(Fₗ(x, y), Fᵣ(x−d, y))+D (Fₗ(x, y), Fₜ(x, y−d))] (Eq. 3)

For the horizontal texture example, although the horizontal distance function D(Fₗ(x, y), Fᵣ(x−d, y)) is constant for a pixel in the texture area, the vertical distance function D (Fₗ(x, y), Fᵣ(x, y−d)) is not a constant function. Therefore, the combined function is not constant and can have a unique minimum value, and a unique disparity value can exist to minimize the combined distance function. Similar to the stereo matching algorithm for a two-sensor system, smoothness constraints can be also added into the cost function to further enhance the accuracy, which basically adds another smoothness term into the combined cost function as shown above. Apart from using two sensor pairs, three sensor pairs created by a triangular positioning can be considered, which can be useful for other triangular spatial configurations, such as the one in FIG. 3. If all of the three sensor pairs are considered, the cost function has three terms. And each term is a cost function corresponding to one sensor pair. However, for the orthogonal sensor configuration in FIG. 1, the above two-term cost function can be accurate enough.

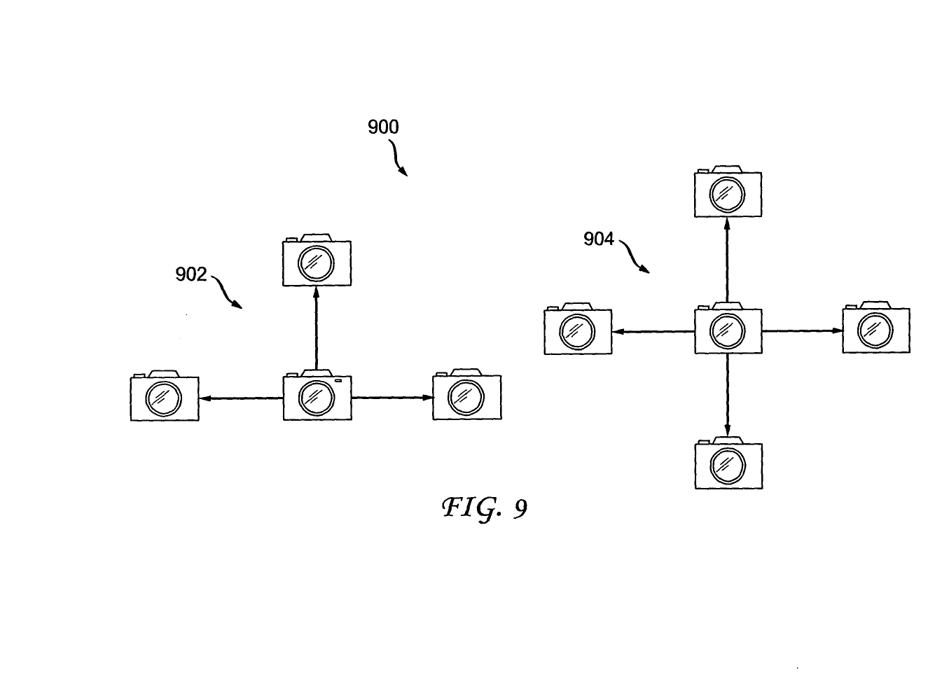

In principle, the orthogonal three-sensor system can be extended to four-sensors 902 or five-sensors 904 or even more, as shown in examples 900 in FIG. 9. But, the orthogonal three-sensor system can be the best in terms of cost-benefit tradeoff. The flexibility of this type of system and methods allows for modifications such as the combination of the feature distance functions can be changed to different formulations and/or the shape of the triangle for placing the sensors can be varied and the like.

It should be noted that instances herein can also include information sent between entities. For example, in one instance, a data packet, transmitted between two or more devices, that facilitates content/services distribution is comprised of, at least in part, information relating to content/service distribution receiver software relayed to content/service distribution receivers via a multicast message.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A depth acquisition system, comprising:
at least two image sensors horizontally positioned in relation to each other in view of an image; and
at least one additional image sensor vertically positioned in view of the image in relation to the other horizontally positioned image sensors.

2. The system of claim 1, wherein the image sensors form at least one horizontal sensor pair and at least one vertical sensor pair.

3. The system of claim 2, wherein at least one baseline of a horizontal sensor pair and at least one baseline of vertical sensor pair are not equal to each other.

4. The system of claim 2, wherein at least one baseline of a horizontal sensor pair and at least one baseline of vertical sensor pair are equal to each other.

5. The system of claim 2, wherein at least one baseline of a horizontal sensor pair and at least one baseline of vertical sensor pair are oriented perpendicular to each other.

6. The system of claim 1, wherein the depth acquisition system is a trinocular depth acquisition system.

7. The system of claim 1, wherein the depth acquisition system is employed in a three-dimensional imaging system.

8. A method for obtaining depth information for an image, comprising the steps of:
capturing image information from at least one pair of horizontally aligned image sensors;
capturing image information from at least one pair of vertically aligned image sensors; and
determining depth information for the image based on the vertically and horizontally aligned sensor information.

9. The method of claim 8, further comprising the step of:
determining vertical edge pixel disparities from the horizontally aligned image sensors; and
determining horizontal edge pixel disparities from the vertically aligned image sensors.

10. The method of claim 8, further comprising the step of:
utilizing horizontally and vertically aligned sensors with differing baselines to capture image information.

11. The method of claim 8, further comprising the step of:
applying smoothness constraints to the depth determination to increase accuracy.

12. The method of claim 8, further comprising the step of:
combining distance information from the sensors using more than one technique.

13. The method of claim 8, further comprising the step of:
transforming disparity information of the horizontally aligned image sensors to vertical disparity information using baseline information of both the horizontally aligned sensors and the vertically aligned sensors.

14. The method of claim 8, further comprising the step of:
determining disparity information for the image using stereo match techniques applied to pairs of horizontally and vertically aligned sensors.

15. A system that acquires image depth information, comprising:
means for capturing image information from horizontally aligned image sensors;
means for capturing image information from vertically aligned image sensors; and
means for determining depth information for the image based on the vertically and horizontally aligned sensor information.
